(19) United States
(12) Patent Application Publication
(10) Pub. No.: US 2022/0379329 A1
(43) Pub. Date: Dec. 1, 2022

(54) PUMP DISPENSER, FILLING APPARATUS AND REPLENISHMENT SYSTEM HAVING A PLURALITY OF PUMP DISPENSERS

(71) Applicant: ADA Cosmetics International GmbH, Kehl (DE)

(72) Inventors: Oliver SEIDEL, Karlsruhe (DE); Stefanie HESS, Friesenheim (DE)

(73) Assignee: ADA Cosmetics International GmbH, Kehl (DE)

(21) Appl. No.: 17/776,101

(22) PCT Filed: Nov. 15, 2019
(86) PCT No.: PCT/EP2019/081524

§ 371 Date: May 11, 2022

(51) Int. Cl. B05B 11/00; A47K 5/12; B67C 3/26

(52) U.S. Cl. CPC B05B 11/0097; A47K 5/1205; B05B 11/3042; B67C 3/26; B67C 2003/2654

(57) ABSTRACT

A pump dispenser for providing and withdrawing liquids including a bottle (1), having a bottle opening (3) for storing and providing the liquid, and a pump lid (2) on and/or in the bottle opening for metered withdrawal of the liquid. The pump lid has a metering pump (4) with a manually operated actuation element, and further includes a lid (6) for closing the bottle and an output device (7). The bottle has a replenishment opening (9) provided in addition to the bottle opening. A replenishment system includes a pump dispenser (33) per usage location (30) and a transportable storage tank (19) for liquids for replenishing the pump dispensers. A filling apparatus (13) withdraws the liquid from the storage tank (19) and introduces the liquid into the pump dispensers (33), the filling apparatus (13) being provided with a filling nozzle (14) or spike for the replenishment openings (9) of the bottles.

### TECHNICAL FIELD

The invention relates to a pump dispenser for providing and withdrawing liquids, in particular cleansing substances and body care products. The invention moreover relates to a replenishment system for a plurality of usage locations, with at least one pump dispenser per usage location and with a transportable storage tank for liquids for replenishing the pump dispensers. The invention furthermore relates to a filling apparatus for such a replenishment system.

### BACKGROUND

A pump dispenser of the present kind accordingly comprises a bottle having a bottle bottom and a bottle opening, the bottle being used for storing and providing the liquid. Furthermore, the pump dispenser comprises a pump lid sitting on and/or in the bottle opening for metered withdrawal of the liquid. In the pump lid there are combined a metering pump with a manually operated actuation element, a lid for closing the bottle, and an output device for a metered liquid pumped out of the bottle.

Such pump dispensers have long been used both in private households and in hotels, as well as public lavatories and the like, primarily in order to provide and meter out liquid soap. In bathrooms and wellness centers of hotels, such pump dispensers are often used not only for liquid soap, but also for shower oils, hair shampoo, and other body care products such as lotions or the like. The liquid products contained therein can be dispensed as needed and withdrawn in a perfectly hygienic manner, without having to use less sustainable, individually packaged small containers for the corresponding body care products to be used once or twice.

The major benefit of dispensers for providing and withdrawing liquids, whether as metered dispensers in wall mounts or as pump dispensers of the present kind, is the possibility of replenishing the dispensing container or bottle. However, especially in hotels, where the housekeeping staff have many usage locations to take care of, the replenishing of pump dispensers of the present kind may be very time-consuming. Normally, the pump dispensers to be replenished are gathered, replenished at a central location, and then distributed once again at the usage locations, especially the hotel rooms. Alternatively, the pump dispensers are replenished as needed on site. In any case, however, the pump lid of each pump dispenser must be unscrewed from the bottle opening for the actual replenishing process, liquid from a storage tank must be placed in an intermediate container and then the pump dispenser bottle must be replenished therefrom through the opened bottle opening. This is time-consuming and tedious, holds up the housekeeping staff, and is accordingly a disliked chore. Furthermore, this replenishment process leaves room for improvement in terms of hygiene aspects, since the liquid product replenished in the pump dispensers is not handled in a closed system protected against contamination.

### SUMMARY

The present invention is therefore based on the problem of proposing a pump dispenser as well as a filling apparatus and a replenishment system for a plurality of pump dispensers of the kind mentioned above, with which the replenishing of the pump dispenser or the pump dispensers is simplified, especially in hotels and the like, and improved in terms of hygiene aspects.

This problem is solved by a pump dispenser having one or more of the features disclosed herein, by a replenishment system having one or more of the features disclosed herein, and by a filling apparatus having one or more of the features disclosed herein. Preferred embodiments of the pump dispenser; advantageous modifications of the replenishment system; and one feasible embodiment of the filling apparatus are described below and in the claims.

A pump dispenser according to the invention having a bottle and a pump lid sitting on and/or in the bottle opening, comprising a metering pump with a manually operated actuation element, a lid for closing the bottle, and an output device for a metered liquid pumped out of the bottle, is accordingly characterized in that the bottle has a replenishment opening which does not coincide with the bottle opening, but instead is arranged preferably on the bottle bottom. Such a separate replenishment opening makes it possible to replenish the pump dispenser without having to remove the pump lid. This already results in a better handling of the pump dispenser during the replenishing process and allows the replenishing of the pump dispenser to be performed with a filling apparatus specially adapted to the replenishment opening. In this way, in particular, it can be assured that the liquid cannot become contaminated during the replenishing process.

Because the separate replenishment opening makes it possible to join the pump lid firmly to the bottle, so that it cannot be removed from the bottle, even the utmost hygiene requirements can be met with the pump dispenser according to the invention. At the same time, by means of a specifically configured replenishment opening and a corresponding mating piece for a filling apparatus, it can be assured that only the liquid suitable or approved for the particular pump dispenser can be replenished. This enhances the product safety as compared to the known pump dispensers.

Finally, a suitable configuration of the replenishment opening enables an especially easy, quick, and intuitive replenishing of the pump dispenser. For this, it is advantageous when the replenishment opening is closed by a valve, which assures the tightness of the bottle both during transport, handling and storage, and during the actuating of the pump lid, and which can preferably be easily opened from the outside, for example by being configured as a check valve. When the check valve is configured as an automatically closing membrane that can be penetrated from the outside or as a duckbill valve, especially one made of silicone, the replenishing of the pump dispenser can be done by introducing a spike or filling nozzle into the check valve. This not only has the advantage that the valve is opened intuitively by introducing the spike or filling nozzle, but also assures a clean working process, since the replenishment liquid generally flows out from the refilling apparatus at the tip of the spike or the filling nozzle, and thus inside the bottle. At the same time, a check valve ensures the tightness of the bottle when the pump dispenser is put back into use after the replenishing, and this occurs advantageously in an automatic manner, i.e., it is not possible to forget about closing a valve or the replenishment opening after the replenishment process.

When the replenishment opening is situated in the bottle bottom, the pump dispenser can very easily be placed on a spike or filling nozzle for the replenishing process, in order to introduce the latter into the valve and thus into the bottle.

For the venting of the pump dispenser according to the invention during the replenishing process, the pump lid is preferably provided with a venting device. This may be formed substantially by a vent opening, being at first tightly closed with a closure. This closure can be opened by the first actuation of the pump dispenser, for example at a predetermined breaking point. This has the advantage that the user need not think about opening the vent opening during the replenishing of the pump dispenser. But it can also be provided that the closure of the vent opening is opened by an action, such as a rotating of the pump lid. This means, conversely, that the vent opening can be closed tightly once more after the replenishing of the pump dispenser.

These examples for a venting device do not rule out the possibility of other venting procedures also being provided within the scope of the present invention, for example, through a coaxial filling nozzle, through the valve of the replenishment opening, through a separate vent opening in the bottle, and so forth.

The replenishment system according to the invention for providing and withdrawing liquids at a plurality of usage locations, with at least one pump dispenser per usage location and with a transportable storage tank for liquids for the replenishing of the pump dispensers, uses pump dispensers designed according to the invention and comprises a filling apparatus, which withdraws the liquid product to be replenished from the storage tank and introduces it into the pump dispenser. This filling apparatus is provided according to the invention with a filling nozzle or spike for the replenishment openings of the bottles of the pump dispensers. With this filling nozzle or spike, as already described, a check valve configured in particular for example as an automatically closing membrane that can be penetrated from the outside or as a duckbill valve, both of them designed preferably in silicone, can be opened by simply placing the bottle on or in the filling apparatus. At the same time, the location at which the replenishing liquid emerges on the filling nozzle or spike is located inside the bottle of the pump dispenser, so that on the one hand the utmost hygiene is assured and on the other hand an accidental leakage during the replenishing process is prevented. The replenishment system according to the invention furthermore has all of the above described advantages of a pump dispenser according to the invention, of course.

The filling apparatus, which is part of the replenishment system according to the invention, preferably comprises a filling pump for the delivery of the liquid from the storage tank to the pump dispensers. This filling pump may be a mechanical pump, actuated by the user. Preferably, however, it is a motorized pump, especially an electrically operated liquid pump. When such a liquid pump is supplied with electric energy for example by means of a storage battery, a replenishment module consisting of storage tank and filling apparatus can also be transportable, alternatively to its use as a stationary, central replenishment station, for example for the housekeeping staff in a hotel, who can then move from one usage location to another in order to replenish any pump dispensers there.

The filling pump of the filling apparatus is preferably actuated by a force acting on the filling nozzle or spike and/or on a switching area surrounding or adjacent to the latter. This switching area can be configured as a plate, ring, collar, parking area, or also simply as a switching area of a switch; the latter especially when the filling pump is operated by an electric motor. A ring or a parking area which is movable and located next to the filling nozzle or spike can also serve as the actuation element of a mechanical filling pump.

The filling apparatus as such and as part of the replenishment system according to the invention is preferably configured as a functional unit which can be removed from the storage tank, yet also in particular connected to it, so that in the end it can form a transportable replenishment module together with the storage tank. The filling apparatus preferably comprises a port adapter, configured to mate with a withdrawal adapter on the storage tank. It can also be ensured here, by appropriate configuration of the respective adapter, that only approved storage tanks can be used for the replenishing of the pump dispensers of the replenishment system.

The latter can also be assured in that the filling apparatus is provided with fastening elements, which are configured for example as holding rails and which fit holding devices on the storage tank. The filling apparatus can then be placed only on approved storage tanks and be transported together with the latter to the individual usage locations of the pump dispensers. It can also be provided that the filling apparatus can only withdraw liquid from the storage tank if it is sitting properly in the holding devices of the storage tank.

Finally, a filling apparatus according to the invention for the replenishment system according to the invention is characterized by the filling nozzle or spike for the replenishment openings of the bottles of the pump dispensers and by a filling pump for the delivery of liquid from the storage tank to the pump dispensers.

### BRIEF DESCRIPTION OF THE DRAWINGS

One exemplary embodiment each for a pump dispenser configured according to the invention and for a replenishment system designed according to the invention and for a filling apparatus configured according to the invention will be explained and described more closely below with the aid of the enclosed drawings, in which:

FIG. 1 shows an exemplary embodiment for a pump dispenser configured according to the invention;

FIG. 2 shows the bottle of the pump dispenser of FIG. 1, in an exploded representation;

FIG. 3 shows a cross-sectional representation of the pump dispenser of FIG. 1 with part of a filling apparatus configured according to the invention;

FIG. 4 shows the pump lid of the pump dispenser of FIG. 1 in cross section;

FIG. 5 shows an exemplary embodiment of a filling apparatus configured according to the invention, shown with a storage tank;

FIG. 6 shows an exemplary embodiment of a replenishment system configured according to the invention with pump dispenser, filling apparatus and storage tank;

FIG. 7 shows a schematic representation of a replenishment system according to the invention;

FIGS. 8A, 8B show two examples for the use of a replenishment system according to the invention;

FIG. 9 shows a schematic representation of the replenishment system according to the invention and its use.

### DETAILED DESCRIPTION

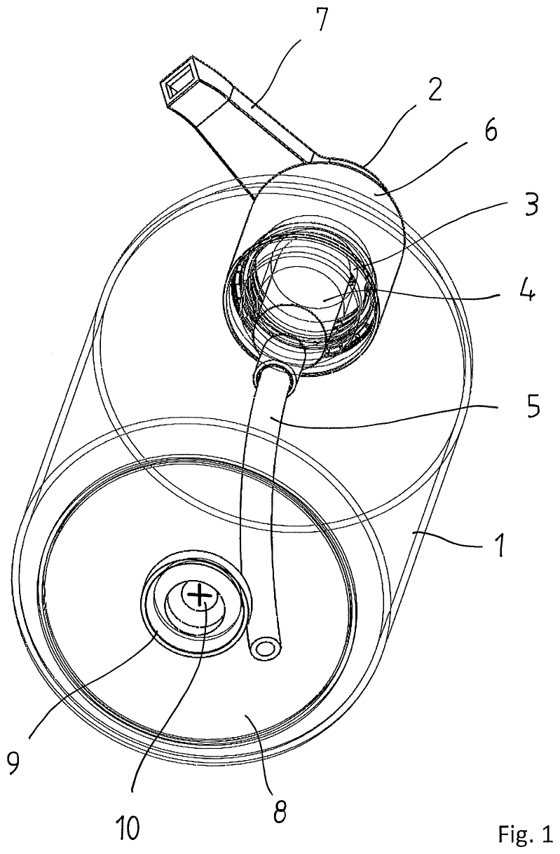

FIG. 1 shows an exemplary embodiment of a pump dispenser configured according to the invention in a front view, slanted from below. This pump dispenser consists of a bottle 1, in the present case one made from a transparent material, and a pump lid 2, which is placed on a bottle opening 3, in the present case being screwed on, and which comprises a metering pump 4 with suction hose 5 for a liquid product located in the bottle 1, a lid 6 for closing the bottle 1, and a beak-shaped output device 7 for the withdrawal of a metered liquid pumped from the bottle 1.

According to the invention, a replenishment opening 9 is provided in a bottle bottom 8 of the bottle 1 and is closed with a check valve 10. This consists in the present instance of a silicone membrane, having a crosswise slit at the center, thereby forming four flaps, which can be penetrated by a spike or a filling nozzle from the outside. If such a spike or filling nozzle is pulled out from the check valve 10 once more, the membrane flaps will automatically close and prevent liquid from escaping from the bottle 1.

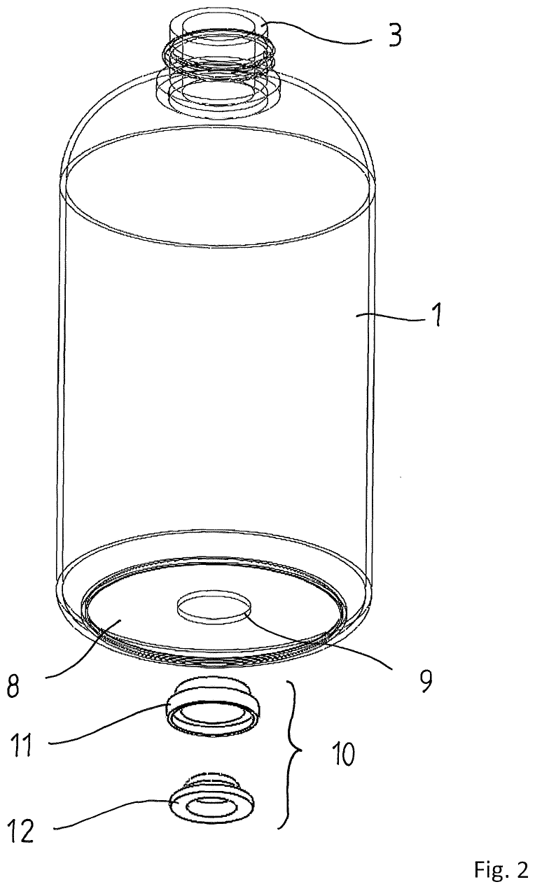

FIG. 2 shows the check valve 10 in an exploded representation together with the bottle 1 of the pump dispenser of FIG. 1, however the pump lid 2 has been removed, so that the bottle opening 3 is visible here. In the bottle bottom 8, there can be seen a circular replenishment opening 9, which is closed by the check valve 10. This consists of a valve body 11 for inserting the check valve 10 into the replenishment opening 9, as well as a silicone membrane 12 supported therein, as already described more fully with the aid of FIG. 1.

As FIG. 2 illustrates, a conventional pump dispenser can be altered by a few modifications to form a pump dispenser configured according to the invention.

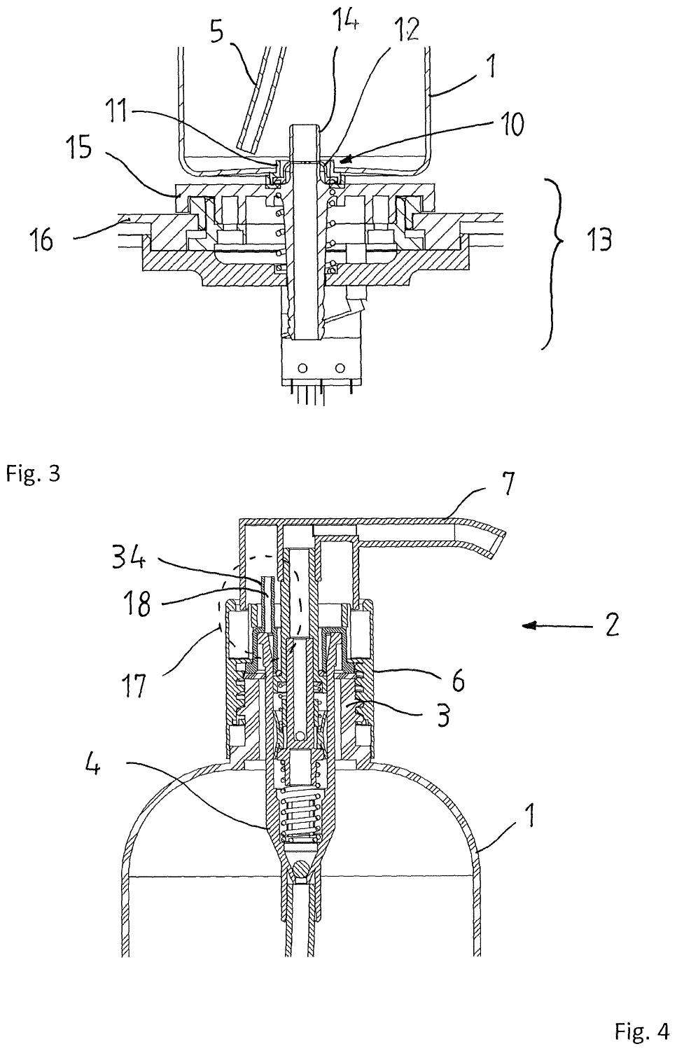

FIG. 3 shows in a schematic sectional representation how the pump dispenser of FIGS. 1 and 2 can be filled through the replenishment opening 9 with a correspondingly configured filling apparatus 13. The filling apparatus 13 has a filling nozzle 14, which together with a switching area 15 encircling it as a ring, being configured as a plate in the present case, extends upward beyond a housing 16 of the filling apparatus 13. Since the filling nozzle 14 is oriented upward, the bottle 1 of the pump dispenser can be placed quite simply on the plate-shaped switching area 15, so that the filling nozzle 14 pierces the membrane 12 of the check valve 10 and penetrates into the interior of the bottle 1. The opening of the filling nozzle 14 is then situated inside the bottle 1, so that the filling of the bottle 1 with liquid can take place in a hygienically closed process with no danger of leakage, also on account of the sealing effect of the membrane 12 made from silicone, among other things.

The switching area 15 of the filling apparatus 13 is vertically movable and when pressed upon from above puts out a signal which activates a filling pump (not shown here) in the filling apparatus 13. Since the switching area 15 is spring-loaded and pretensioned upward, the filling pump and thus the replenishment process is halted as soon as no more force is exerted from above on the switching area 15 or the filling nozzle 14 firmly connected to it.

As shown by FIG. 4 in a schematic cross-sectional representation, the venting of the interior space of the bottle 1 during the replenishment process occurs via the pump lid 2. This is modified such that it contains a venting device 17, which is symbolized in FIG. 4 by means of an elliptical line. For this, an additional vent opening 18 is provided in the exemplary pump lid 2 depicted, having an upwardly extending venting pipe 34 like a chimney. The venting pipe 34 prevents water from being able to get into the vent opening 18, which is constantly open. Depending on the design of the pump lid used, other venting devices 17 can also be provided, which for example can be opened or closed as desired by rotating the pump lid 2 about the vertical axis. In this case, it can also be provided that such a rotation is only required during the first use of the pump dispenser, after which the vent opening 18 then remains open. This ensures that one cannot forget to open the vent opening 18 during the replenishing process.

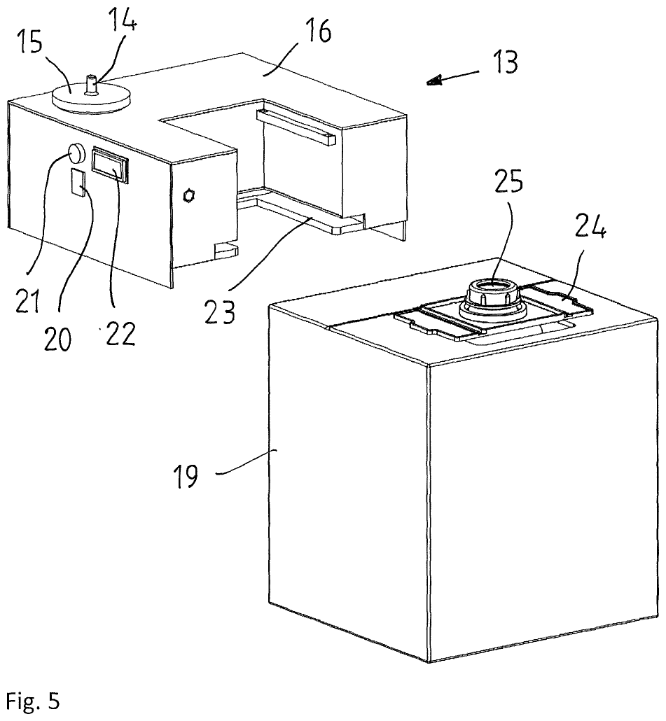

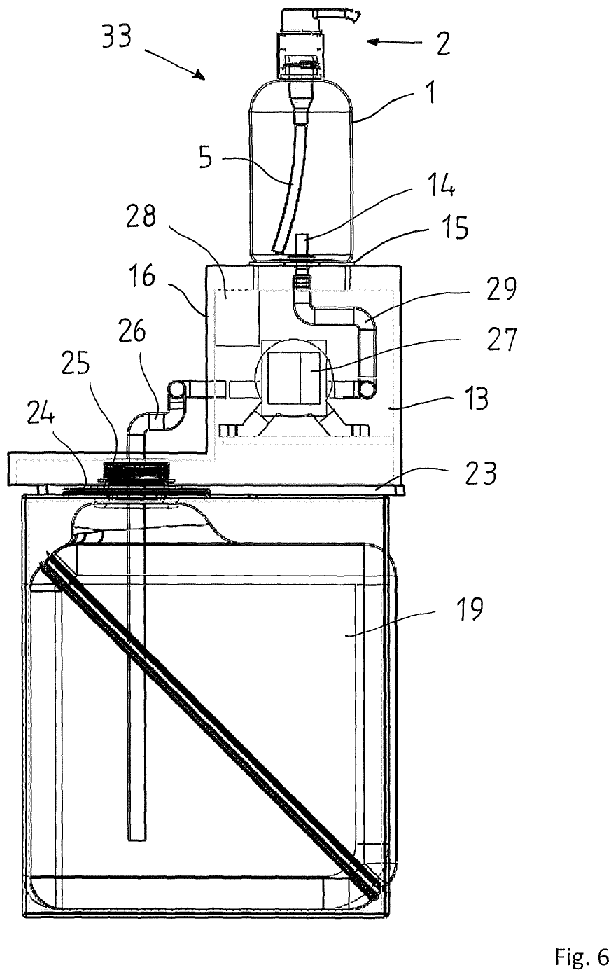

FIG. 5 is a schematic representation of a filling apparatus 13 according to the invention, which can be placed on a storage tank 19. One can see the housing 16 of the filling apparatus 13, the filling nozzle 14 rising above the housing 16 with plate-shaped switching area 15, an On/Off switch 20, an operating display 21, a charge state display 22 for a storage battery (not shown here) installed in the housing 16, and fastening elements 23 configured as holding rails, by which the filling apparatus 13 can be inserted to fit in correspondingly configured holding devices 24 on the storage tank 19. The storage tank 19, for its part, is provided with a port 25, to which only a mating suction line 26 of the filling apparatus 13 can be connected by the lock and key principle (see FIG. 6).

FIG. 6 shows in a schematic representation the interworking of the pump dispenser 33 with the storage tank 19 and the filling apparatus 13 connected in between, having been placed here on the storage tank 19 and being ready to operate. The individual elements of these components of a replenishment system according to the invention are given the reference numbers already explained in the case of FIGS. 1 to 5, so that reference can be made to the above description in this respect. FIG. 6 furthermore shows the “inner workings” of the filling apparatus 13, namely, a filling pump 27 operated by an electric motor and configured as a membrane pump, being supplied with electric energy by a storage battery 28 and pumping liquid from the storage tank 19 to the bottle 1 by means of the suction line 26 and a pressure line 29. This is the case as long as an operator presses the pump dispenser 33 down onto the filling nozzle 14 or the switching area 15, so that the switching area 15 is moved downward against a spring force. Once no further force is applied to the switching area 15 or the filling nozzle 14, the filling pump 27 halts the replenishment process. The pump dispenser 33 can then be removed simply and cleanly from the filling nozzle 14, whereupon the valve 10 closes once more.

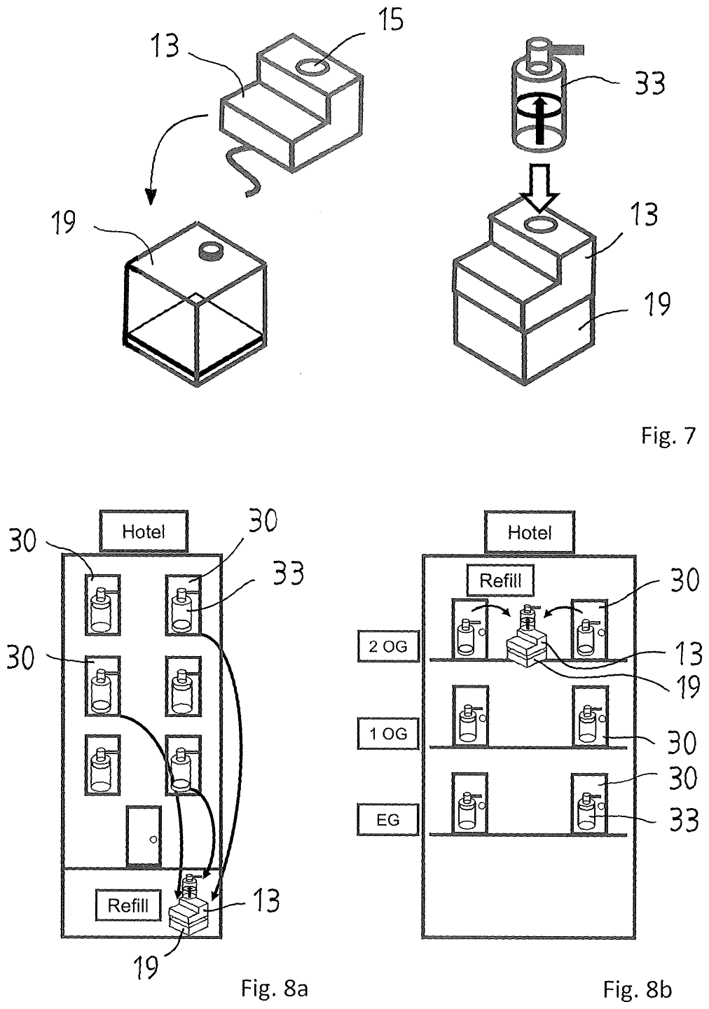

FIG. 7 shows yet again in a symbolic representation the replenishment system according to the invention with pump dispenser 33, filling apparatus 13 and storage tank 19. After placing the filling apparatus 13 on the storage tank 19, a transportable replenishment module is formed, which can be transported from room to room in a hotel, for example, and for the replenishing of the pump dispensers 33 it can be simply placed or pressed down onto the switching area 15.

The transport of the replenishment module from room to room is symbolized by FIG. 8B, while FIG. 8A shows another kind of use, namely, a centralized replenishing of pump dispensers 33, which are positioned at a plurality of usage locations 30, here being hotel rooms, and which are collected for the replenishing process.

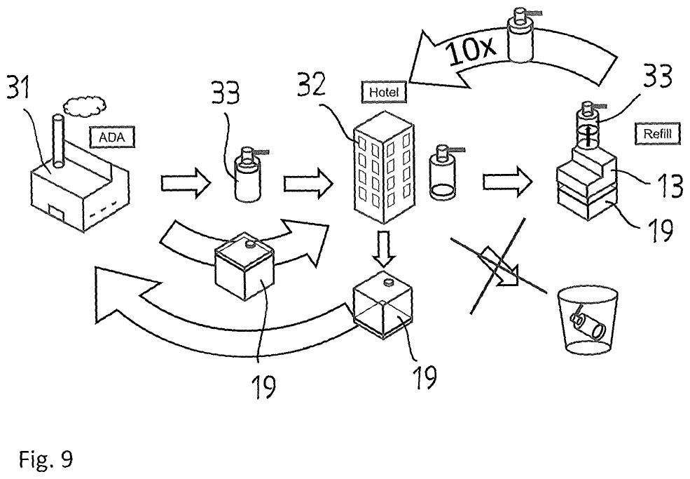

FIG. 9 is another symbolic representation of a replenishment system configured according to the invention, where a manufacturer 31 delivers both the pump dispensers 33 and the storage tanks 19 to a user 32, here a hotel, where the pump dispensers 33 are constantly filled once more from the storage tanks 19 by means of the filling apparatus 13 and therefore do not end up in the trash. The empty storage tanks 19 can likewise be filled once more at the manufacturer 31.

As FIG. 9 makes clear, the replenishment system according to the invention is a highly sustainable system, which is not only eminently advantageous from environmental aspects, but also offers cost benefits for all involved. Furthermore, a contact between the liquid products, which are provided in the pump dispenser 33 at the user, and the surroundings is largely prevented, so that the replenishment system according to the invention is also especially advantageous from hygiene standpoints. When the pump lids 2 of the pump dispensers 33 are firmly connected to the bottle 1, i.e., cannot be unscrewed as in the case of customary pump dispensers, an especially advantageous closed system is realized also under hygiene standpoints.

1. A pump dispenser for providing and withdrawing liquids, the pump dispenser comprising:
a bottle (1) having a bottle bottom (8) and a bottle opening (3) for storing and providing the liquid,
a pump lid (2) sitting on and/or in the bottle opening (3) for metered withdrawal of the liquid,
the pump lid (2) comprises a metering pump (4) with a manually operated actuation element, a lid (6) for closing the bottle (1),
an output device (7) for a metered liquid pumped out of the bottle (1), and
a replenishment opening (9) in the bottle provided in addition to the bottle opening (3).

2. The pump dispenser as claimed in claim 1, further comprising a valve (10) that closes the replenishment opening (9).

3. The pump dispenser as claimed in claim 2, wherein the valve (10) of the replenishment opening (9) is configured as a check valve.

4. The pump dispenser as claimed in claim 2, wherein the valve (10) is configured as an automatically closing membrane (12) that is penetratable from outside or as a duckbill valve.

5. The pump dispenser as claimed in claim 1, wherein the pump lid (2) further includes a venting device (17).

6. The pump dispenser as claimed in claim 5, wherein the venting device (17) is formed by a vent opening (18) having a closure which is opened by a first actuation or by rotating of the pump lid (2).

7. The pump dispenser as claimed in claim 1, wherein the bottle (1) of the pump dispenser is provided with a venting device (17), comprising a vent opening (18) in the bottle (1) or in the replenishment opening (9).

8. The pump dispenser as claimed in claim 1, wherein the replenishment opening (9) is situated in the bottle bottom (8).

9. The pump dispenser as claimed in claim 1, wherein the pump lid (2) is connected to the bottle (1) and is secured against removal.

10. A replenishment system for a plurality of usage locations (30), the system comprising
at least one of the pump dispensers (33) according to claim 1 per usage location (30) and having at least one transportable storage tank (19) for liquids for replenishing the pump dispensers (33),
a filling apparatus (13) for withdrawing the liquid from the storage tank (19) and introducing the liquid into the pump dispensers (33), wherein the filling apparatus (13) includes a filling nozzle (14) or spike configured for the replenishment openings (9) of the bottles (1) of the pump dispensers (33).

11. The replenishment system as claimed in claim 10, wherein the filling apparatus (13) comprises a filling pump (27) for the delivery of the liquid from the storage tank (19) to the pump dispensers (33).

12. The replenishment system as claimed in claim 11, wherein the filling pump (27) is actuatable by a force acting on the filling nozzle (14) or spike, or on a switching area (15) surrounding or adjacent to the spike.

13. The replenishment system as claimed in claim 1, wherein the filling apparatus (13) is configured as a functional unit which is loosenable from and connected to the storage tank (19).

14. The replenishment system as claimed in claim 13, wherein the filling apparatus (13) further comprises a port adapter configured to fit a port (25) on the storage tank (19).

15. The replenishment system as claimed in claim 13, wherein the storage tank (19) includes holding devices (24) for mating fastening elements (23) on the filling apparatus (13).

16. The replenishment system as claimed in claim 10, further comprising a venting device (17) integrated in the filling nozzle (14) for venting the bottle (1).

17. A filling apparatus for a replenishment system, the filling apparatus comprising:
a filling nozzle (14) or spike configured for a replenishment opening (9) of a pump dispenser (33), and
a fluid-delivering filling pump (27) for delivering liquid from a storage tank (19) to the pump dispenser (33).

18. The filling apparatus as claimed in claim 17, wherein the filling pump (27) is actuatable by a switch or by a force acting on the filling nozzle (14) or spike, or on a switching area (15) surrounding or adjacent to the spike.
